(19) United States
(12) Patent Application Publication
(10) Pub. No.: US 2025/0355203 A1
(43) Pub. Date: Nov. 20, 2025

(54) CO-PACKAGED OPTICAL FIBER MOUNTING UNIT AND METHOD OF FABRICATION

(71) Applicant: Taiwan Semiconductor Manufacturing Company, Ltd., Hsinchu (TW)

(72) Inventor: Chan-Hong Chern, Palo Alto, CA (US)

(21) Appl. No.: 18/668,631

(22) Filed: May 20, 2024

(51) Int. Cl. G02B 6/42

(52) U.S. Cl. CPC G02B 6/4268; G02B 6/4239; G02B 6/424

(57) ABSTRACT

An optical engine (OE) and a fiber mounting unit (FMU) are mounted side-by-side on a package substrate in a chip package. The OE includes an electrical integrated circuit (EIC) die and a photonic integrated circuit (PIC) die in a vertical stack. A core of an optical fiber may be passed through the FMU and maintained by the FMU in alignment with an edge coupler within the PIC die. The optical fiber may be separately supported by a fixture that is co-mounted with the chip package on a printed circuit board (PCB). A heat spreader may be placed over the chip package. Vertical stacking in the OE reduces electrical loses between the EIC and the PIC. Use of an edge coupler rather than a grating coupler leaves room for the heat spreader. The FMU enables precision alignment of the optical fiber to the edge coupler.

### BACKGROUND

As semiconductor technology continues to advance, there is an ever-increasing demand for higher-performance devices with smaller form-factors. As part of a solution for meeting these demands, a plurality of substrates may be vertically stacked within a chip package. Higher-performance, smaller form-factor, and vertical stacking all make thermal management more difficult. Heat, if not properly managed, can degrade the performance of integrated circuit (IC) devices, reduce their lifespan, or even cause catastrophic failure. Thermal management techniques include the use of heat spreaders, heat sinks, and thermal interface materials (TIMs).

### BRIEF DESCRIPTION OF THE DRAWINGS

Aspects of the present disclosure are best understood from the following detailed description when read with the accompanying figures. In accordance with standard industry practice, features are not drawn to scale. Moreover, the dimensions of various features within individual drawings may be arbitrarily increased or reduced relative to one-another to facilitate illustration or provide emphasis.

FIG. 1 illustrates a cross-sectional view of a system including a chip package according to some aspects of the present disclosure.

FIGS. 2A-2D illustrate end views according to various embodiment of a fiber mounting unit (FMU).

FIGS. 3A-3B illustrate end views of another FMU according to various other embodiments.

FIGS. 4-7 illustrate cross-sectional views of systems including chip packages according to various embodiments of the present disclosure.

FIGS. 7A-7C illustrate end views of an optical engine photonic integrated circuit (OE PIC) in accordance with various embodiments.

FIGS. 8-14 illustrate cross-sectional views of systems including chip packages according to various other embodiments.

FIGS. 15-18 provide a series of cross-sectional views illustrating a process of forming and using a chip package according to the present disclosure.

FIG. 19 provides flow chart for a manufacturing process according to some embodiments of the present disclosure.

FIG. 20 provides flow chart for a manufacturing process according to some other embodiments of the present disclosure.

### DETAILED DESCRIPTION

The present disclosure provides many different embodiments, or examples, for implementing different features of this disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact.

Spatially relative terms, such as “beneath,” “below,” “lower,” “above,” “upper”, and the like, may be used herein to describe one element or feature's relationship to another element(s) or feature(s) as illustrated in the figures. These spatially relative terms are intended to encompass different orientations of the device or apparatus in use or operation in addition to the orientation depicted in the figures. The device or apparatus may be otherwise oriented (rotated 90 degrees or at other orientations) and the spatially relative descriptors used herein may be interpreted accordingly. Terms “first”, “second”, “third”, “fourth”, and the like are merely generic identifiers and, as such, may be interchanged in various embodiments. For example, while an element (e.g., an opening) may be referred to as a “first” element in some embodiments, the element may be referred to as a “second” element in other embodiments.

Optical signals have important advantages over electrical signals, particularly for high frequency or high data rate transmissions over long distances. Accordingly, a high performance chip package may include a photonic integrated circuit (PIC) chip in addition to one or more electrical integrated circuit (EIC) chips. In one configuration, the chip package includes an optical engine (OE) having a PIC chip (OE PIC die) and an EIC (OE EIC die) that cooperate to transmit and/or receive signals over an optical transmission medium.

The OE EIC die includes electrical circuits that drive or control photonic components in the OE PIC die and/or electrical circuits that process signals from the OE PIC die. In some packages, the OE EIC die and the OE PIC die are disposed in a 2.5D structure. In a 2.5D structure, the OE EIC die and the OE PIC die are disposed side-by-side over a package substrate and may have a same elevation and/or have bottom surfaces that are coplanar. The package substrate may be the type that includes a dielectric substrate of the type that includes a semiconductor substrate. If the package substrate includes a semiconductor substrate, it is called a silicon interposer. The package substrate routes signals between the OE EIC die and the OE PIC die.

According to one aspect of the present disclosure, the OE EIC die and the OE PIC die are disposed in a 3D structure. In the 3D structure, the OE EIC die and the OE PIC die are vertically stacked. The 3D structure significantly reduces electrical transmission losses and is more conducive than is the 2.5D structure to the demands of the highest performing chip packages. The 3D structure, however, creates significant challenges with respect to coupling the OE PIC die to optical fibers and thermal management of the OE EIC die and other EICs in the chip package.

In the 2.5D structure, the OE PIC die would typically use grating couplers to provide an optical interface with a fiber optic array. Grating couplers are generally easier to align than edge couplers. A fixture may hold the fiber optic array over the grating couplers. Issues arise when transitioning to higher performing devices having the 3D-structure. If the OE PIC die is placed on top of the OE EIC die, the OE PIC die blocks heat dissipation from the OE EIC die and the fixture may interfere with effective placement of heat spreaders and the like. If the OE EIC die is placed on top of the OE PIC die a distance between the fiber optic array and the OE PIC die is increased and made more variable, which increases sensitivity to misalignment and reduces coupling efficiency.

According to another aspect of the present disclosure the OE PIC die comprises edge couplers for interfacing with a fiber optic array and the problem of aligning the optical fibers with the edge couplers is solved using a fiber mounting unit (FMU) mounted side-by-side with the OE on a package substrate. The FMU holds one or more optical fibers in alignment with corresponding edge couplers in the OE PIC die. In some embodiments, the optical fibers are aligned by trenches in the FMU. In some embodiments, The FMU has V-shaped grooves at the bottoms of the trenches to facilitate precise positioning. In some embodiments, the optical fibers are embedded in the FMU. In some embodiments, the optical fibers are stripped prior to placement in or on the FMU so that the fiber cores may be closely spaced. In some embodiments, a fiber array unit comprising the optical fibers is placed in the FMU. In some embodiments, the fiber array unit comprises a plurality of fiber optic cores embedded in one cladding.

In some embodiments, the OE PIC die has trenches that provide pedestals for the fiber cores. These structures operate in conjunction with the FMU and may increase the precision with which the fiber cores are held in alignment with the edge couplers. If the FMU has trenches for the fiber cores, the OE PIC die trenches are in alignment with the FMU trenches. In some embodiments, the OE PIC die trenches have rectangular cross-sections. In some embodiments, the OE PIC die trenches have V-shaped grooves at their bottoms.

The FMU may hold the optical fibers at a height of the edge couplers whether the OE PIC die is above or below the OE EIC die. Accordingly, in some embodiments, the OE PIC die is over the OE EIC die. In some other embodiments, the OE EIC die is on top. Placing the OE EIC die over the OE PIC die may be advantageous in that the OE EIC die may be proximate a heat spreader or other thermal management device disposed over the OE. Nevertheless, in some cases a similar advantage may be realized when the OE PIC die is over the OE EIC die. For example, an additional EIC die may be vertically stacked with the OE EIC side-by-side with the OE PIC die at the top of the stack. The additional EIC die is then in position to communicate with the OE EIC die with low electrical transmission losses and is also in position to be efficiently cooled by a heat spreader over the chip package.

In some embodiments, the FMU has an upper surface that has a same elevation as and/or is coplanar with an upper surface of the OE. In some embodiments, a heat spreader is placed over the OE and the FMU. The FMU may support the heat spreader or facilitate positioning the heat spreader. In some embodiments, the chip package contains additional EIC dies, one or more of which also has an upper surface that has the same elevation as and/or is coplanar with the upper surface of the OE. The heat spreader may extend over the upper surface of the additional EIC die.

In some embodiments, the OE and the FMU abut. Placing the FMU and the OE in abutment may facilitate controlling a distance between the fiber cores and the edge couplers. In some embodiments, ends of the fiber cores are in alignment with a side of the FMU that faces the OE. In some embodiments, the OE EIC die is horizontally aligned with the OE PIC die on a side of the OE that faces the FMU. This configuration allows both the OE EIC die and the OE PIC die to abut the FMU and may facilitate stable positioning of the FMU adjacent the OE.

In some embodiments, both the OE and the FMU are attached to the package substrate by the same type of attachment structure. In some embodiments, the attachment structure includes the solder bumps of a controlled collapse chip connection (C4 solder bumps). At least some of the C4 solder bumps that hold the OE to the package substrate couple to electrical circuits within the OE. The FMU, on the other hand, may not have any electrical circuits. Nevertheless, in some embodiment, a bottom surface of the FMU is inlaid with bond pads that provide attachment points for C4 solder bumps. Using the same type of connection for both the OE and the FMU may facilitate controlling the elevation of the FMU so that the FMU holds the optical fibers at the correct height for the edge couplers of the OE PIC die.

In some embodiments, the FMU is glued to the package substrate. The FMU may be composed of a dielectric material that is most easily attached to the package substrate by gluing. The FMU may be designed to account for a difference between the thickness of the glue and the height of a C4 connection layer or like structure used to hold the OE to the package substrate.

In some embodiments, the FMU is bonded directly to the package substrate. In some embodiments, the bonding is dielectric-to-dielectric bonding. In some embodiments, the bonding is metal-to-metal. In some embodiments, the bonding includes both dielectric-to-dielectric and metal-to-metal bonding. The FMU may be formed of metal or inlaid with metal bond pads to provide metal-to-metal bonding. Dielectric-to-dielectric bonding with metal-to-metal bonding may be a type of covalent bonding or hybrid bonding. Direct bonding eliminates a degree of variability in the elevation of the FMU with respect to the package substrate.

In some embodiments, the package substrate includes a dielectric substrate. In some embodiments, the package substrate is a silicon interposer, which is a package substrate comprising a semiconductor substrate. A silicon interposer will support a higher density of connections. Dielectric substrates are less expensive and may be easier to use. In some embodiments, a ball grid array (BGA) is disposed on an opposite side of the package substrate from the OE and the FMU. The BGA may be used to mount the chip package to a printed circuit board (PCB).

In some embodiments, the optical fibers are supported by a fixture that is attached to the same PCB as the chip package. Portions of the optical fibers that have cladding are held by the fixture. The fixture may provide mechanical support for the optical fibers so as to reduce mechanical stress on the end portions that have been stripped of cladding. Accordingly, the optical fibers are held in position by both the fixture and the FMU. In some embodiments, the optical fibers are further held in position by pedestals within the OE PIC die.

Some aspects of the present disclosure relate to a process of assembling a chip package that includes an OE. The method includes forming an OE including an OE PIC die and an OE EIC die in a stacked arrangement and mounting the OE and the FMU side-by-side on a package substrate. In some embodiments, the FMU abuts the OE. In some embodiments, additional EIC dies are mounted on the package substrate. The package substrate is mounted on a PCB to which a fixture is attached. An optical fiber is attached to the fixture and the cladding is stripped from an end of the optical fiber. The end is placed in a cavity in the FMU, whereby the optical fiber is aligned with an edge coupler in the OE PIC die. In some embodiments, the end extends past the FMU into an aligned cavity in the OE PIC die. In some embodiments, the cavity is filled so that the end is embedded with the FMU. The method may further include placing a heat spreader over the OE. In some embodiments, the FMU is used to support the heat spreader.

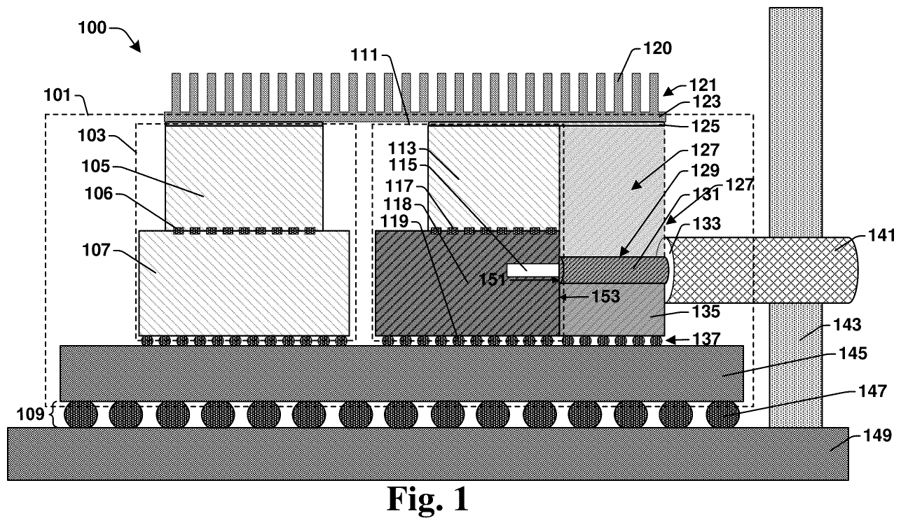

FIG. 1 illustrates a cross-sectional view of a system 100 in accordance with some embodiments. The system 100 includes a chip package 101 electrically coupled and mechanically attached to a PCB 149. The chip package 101 includes a package substrate 145, a first EIC die 105, a second EIC die 107, an OE 111, and an FMU 135. The OE 111 includes an OE PIC die 118 and an OE EIC die 113 in a vertical stack with the OE EIC die 113 above the OE PIC die 118. The first EIC die 105 and the second EIC die 107 are in another vertical stack 103. The vertical stack 103, the OE 111, and the FMU 135 are mounted on the package substrate 145. The OE 111 abuts the FMU 135, and the OE EIC die 113 and the OE PIC die 118 are horizontally aligned on a side of the OE 111 that faces the FMU 135.

An optical fiber 141 having cladding 133 and a core 131 is supported by a fixture 143 that is attached to the PCB 149. The cladding 133 is stripped from an end portion 129 of the optical fiber 141. The end portion 129 rests in a cavity 127 within the FMU 135 and is thereby held in alignment with an edge coupler 115 that is part of the OE PIC die 118. The end aligned with an edge coupler in the OE PIC die 118. A tip 151 of the end portion 129 may be aligned with an edge 153 of the OE PIC die 118.

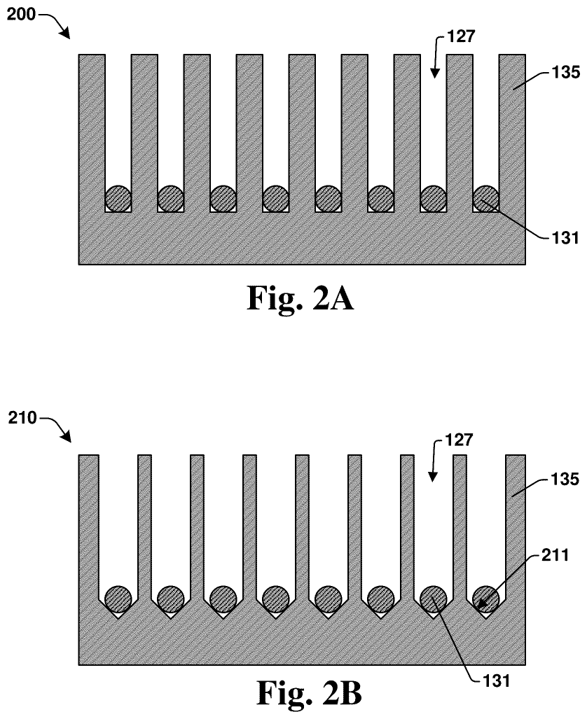

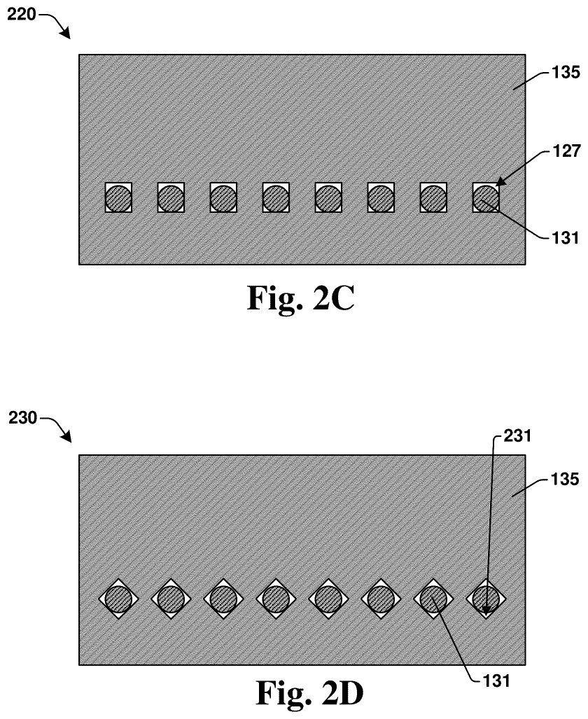

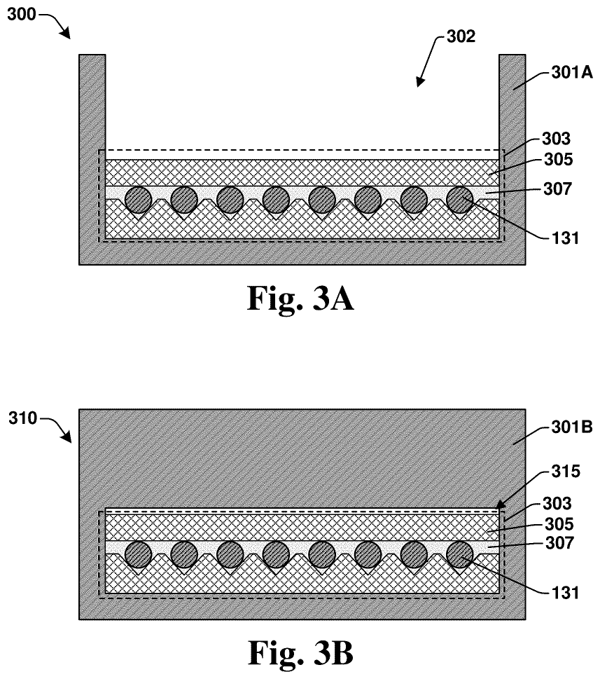

FIG. 2A provides an end view 200 of the FMU 135 in accordance with one embodiment. In the end view 200, the cavities 127 of the FMU 135 are trenches have rectangular shapes. There may be a plurality of cavities 127. Accordingly, the optical fiber 141 (see FIG. 1) may be one of a plurality of optical fibers 141 in a fiber array.

FIG. 2B provides an end view 210 of the FMU 135 in accordance with another embodiment. In the end view 210, the cavities 127 have V-shaped grooves 211 at their bases. The V-shaped grooves 211 may help fix the positions of the cores 131.

FIG. 2C provides an end view 220 of the FMU 135 in accordance with another embodiment. In the end view 220, the cavities 127 are holes through the FMU 135 rather than trenches.

FIG. 2D provides an end view 230 of the FMU 135 in accordance with another embodiment. In the end view 230, the cavities 127 have V-shaped bottoms 231. The V-shaped bottoms 231 may help fix the positions of the cores 131.

FIG. 3A provides an end view 300 of an FMU 301A that may be used in place of the FMU 135 of FIG. 1. The FMU 301A differs from the FMU 135 in that instead of having cavities 127 for receiving individual cores 131 (see FIGS. 2A-2D), the FMU 301A has a cavity 302 which is much larger and sized to receive a fiber array unit 303. The fiber array unit 303 comprises a plurality of cores 131 embedded in cladding 307. The cladding 307 may be inside a sheath 305. Because all the cores 131 are embedded in one cladding 307, they may be placed more closely together than if each were separately clad. For example, a core 131 may have a diameter in the range from about 8 micrometers to about 10 micrometers. The cladding 133 (see FIG. 1) may have a diameter of about 125 micrometers, i.e., greater than 10 times that of the core. Moreover, there may be a protective layer around the cladding that is about 250 micrometers in diameter, i.e., greater than 20 times that of the core. In some embodiments, the cores 131 in the fiber array unit 303 have a pitch of about 10 times or less the diameter of the cores 131. In some embodiments, the cores 131 in the fiber array unit 303 have a pitch of about 5 times or less the diameter of the cores 131.

FIG. 3B provides an end view 310 of an FMU 301B. The FMU 301B differs from the FMU 301A in that it contains a slot 315 for receiving the fiber array unit 303.

Returning to FIG. 1, a heat sink 121 that includes a heat spreader 123 is disposed over the chip package 101. A thermal interface material 125 may be applied to the first EIC die 105, the OE EIC die 113, and optionally the FMU 135 to improve heat transfer between the chip package 101 and the heat sink 121.

The OE EIC die 113 and the OE PIC die 118 may be bonded together through contact pads 117, solder micro bumps, the like, or by any other suitable structure, such as hybrid-bond. Likewise, the first EIC die 105 and the second EIC die 107 may be bonded together through contact pads 106, solder micro bumps, the like, or by any other suitable structure, such as hybrid-bond. The vertical stack 103, the OE 111, and the FMU 135 are bonded to the package substrate 145 by controlled collapse chip connection (C4) solder bumps 119 in C4 connection structures 137, the like, or by some other structures that provide electrical connections for the vertical stack 103 and the OE 111. The chip package 101 is connected to the PCB 149 by solder balls 147 in a ball grid array (BGA) 109, by wires, the like, or by some other suitable structure.

The edge coupler 115 may be a silicon edge coupler, a silicon nitride edge coupler, an oxynitride edge coupler, a poly-silicon coupler, an amorphous-silicon coupler, the like, or any other type of edge coupler. In some embodiments, the edge coupler 115 includes a plurality of optical core segments that are polarization independent so that the edge coupler 115 is operable to receive a wide range of wavelengths. In some embodiments, the OE 111 supports wavelength division multiplexing (WDM). WDM enables high data transmission rates.

In addition to the edge coupler 115, the OE PIC die 118 includes one or more photonic devices that transmit, receive, propagate, generate, modify, or detect optical signals and elements that transform optical signals to electrical signals or electrical signals to optical signals. Examples of photonic devices include waveguides, splitters, multiplexers, filters, modulators (e.g., a PIN modulator or an electro-absorption modulator), sensors, switches (e.g., a Mach-Zehnder interferometer), amplifiers, edge couplers, ring resonators, and the like. Examples of elements that transforms electrical signals to optical signals include laser diodes, light-emitting diodes, and the like. Examples of elements that transform optical signals to electrical signals include photodetectors and the like.

The OE EIC die 113 is configured to receive electrical signals from the OE PIC die 118. These electrical signals may correspond to optical signals received by the OE PIC die 118 from the optical fiber 141. The OE EIC die 113 further includes circuitry that sends electrical signals to the OE PIC die 118 including electrical signals that control and/or provide power to components of the OE PIC die 118. The circuitry of the OE EIC die 113 may enable functions of the OE PIC die 118 by providing signal processing, control, drivers, or the like. Signal processing may include amplification, filtering, or the like. An amplifier in the OE EIC die 113 may correspond with a photodetector or the like in the OE PIC die 118. A driver in the OE EIC die 113 may drive a laser diode a light-emitting diode, modulator, or the like in the OE PIC die 118. The OE EIC die 113 may also provide an interface between the OE PIC die 118 and the second EIC die 107. Optionally, the OE EIC die 113 provides additional functionality unrelated to the OE PIC die 118.

Each of the first EIC die 105 and the second EIC die 107 may include digital, analog, or mixed signal circuits and may be or comprise, for example, a switch chip, a system-on-chip (SOC), an application-specific integrated circuit (ASIC), a central processing unit (CPU), a graphics processing unit (GPU), a data processing unit (DPU), a memory device, a power management unit (PMU), or the like. The first EIC die 105 and the second EIC die 107 may include semiconductor devices such as transistors, diodes, capacitors, memory cells, thyristors, resistors, the like, or any combination thereof. Transistors may be complementary metal-oxide semiconductor (CMOS) transistors, planar CMOS transistors, fin field-effect transistors (FinFETs), gate-all-around (GAA) transistors, nanosheet transistors, or any other suitable type of transistor. A memory device may be high bandwidth memory (HBM), static random access memory (SRAM), dynamic random access memory (DRAM), non-volatile memory (NVM), three dimensional (3D) memory, compute-in-memory (CIM), some other suitable memory, or any combination of the foregoing. The memory device may include resistive random-access memory (RRAM) cells, phase-change memory (PCM) cells, magnetoresistive random access memory (MRAM) cells, the like, or some other type of memory cell.

The package substrate 145 includes a substrate and provides routing of electrical signals. The package substrate 145 may include metal interconnect layers, via layers, through substrate vias (TSVs), contact pads, and the like. In some embodiments, the substrate is a dielectric substrate. A dielectric substrate may be, for example, an organic polymer substrate, the like, or some other suitable dielectric material. Examples of organic polymer substrate materials include, without limitation, polyimide, polytetrafluoroethylene, epoxies, and the like. An epoxy may be one formed from Bismaleimide-Triazine resin (BT-resin), some other epoxy resin, or the like. A dielectric substrate may be a laminate and may be reinforced with glass cloth, fiberglass, or the like. In some embodiments, the substrate is a semiconductor substrate. The semiconductor may be silicon (Si), a group III-V semiconductor (e.g., GaAs) or some other binary semiconductor, a tertiary semiconductor (e.g., AlGaAs), a higher order semiconductor, the like, or any other suitable semiconductor.

The FMU 135 may have any suitable composition. In some embodiments, the FMU 135 is or comprises a dielectric. In some embodiments, the FMU 135 is or comprises an organic polymer. The organic polymer may be for, example, a polyimide, polytetrafluoroethylene, an epoxy, or the like. Organic polymers can be rigid, light weight, and easily provided with a suitable shape.

The heat sink 121 is a radiator that includes a heat spreader 123. A heat spreader may be any structure that is a good heat conductor and rests on the chip package 101. The heat sink 121 may be or comprise a metal, such as aluminum, copper, nickel, cobalt, some other metal, an alloy thereof, or the like, or may be another good heat conductor such as, graphite, or the like. In some embodiments, the heat sink 121 includes fins 120.

The thermal interface material 125 may be a soft material that is a good heat conductor and may be used to improve thermal contact between the OE EIC die 113 and the heat spreader 123. The thermal interface material 125 may be, for example, a polymer, a wax, a viscous silicone compound, a combination of the foregoing, or the like. In some embodiments, the thermal interface material 125 is a grease, a gel, or the like.

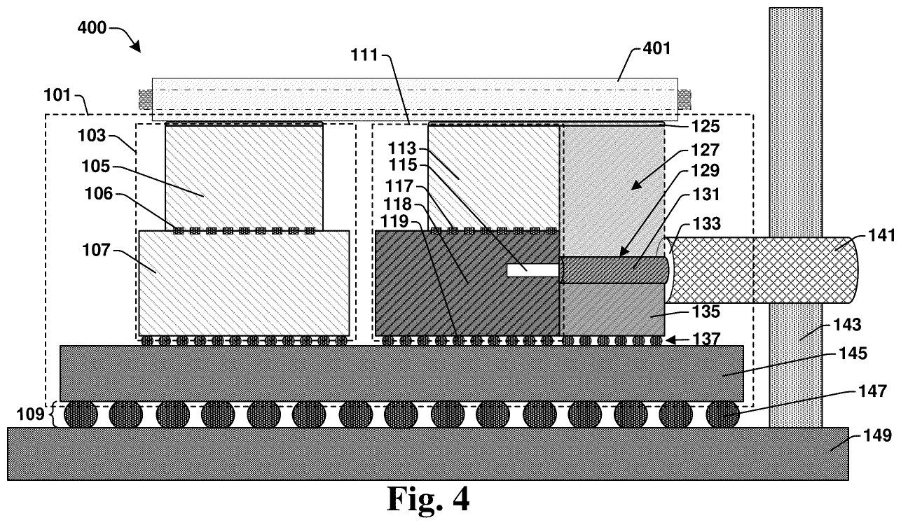

FIG. 4 illustrates a cross-sectional view of a system 400. The system 400 is like the system 100 of FIG. 1 except that the system 400 includes a cold plate 401 in place of the heat sink 121. The cold plate 401 is in one respect a heat spreader but is also part of a liquid cooling system. The liquid cooling system includes the cold plate 401, a radiator (not shown), and a pump (not show). The radiator and the cold plate 401 have internal passages and may be interconnected through hoses or the like. The pump circulates fluid between the radiator and the cold plate 401 so that heat is carried from the cold plate 401 to the radiator. The radiator may be placed at a remote location and releases heat drawn from the cold plate 401 to the surrounding environment. A fan may be directed at the radiator to increase its efficiency.

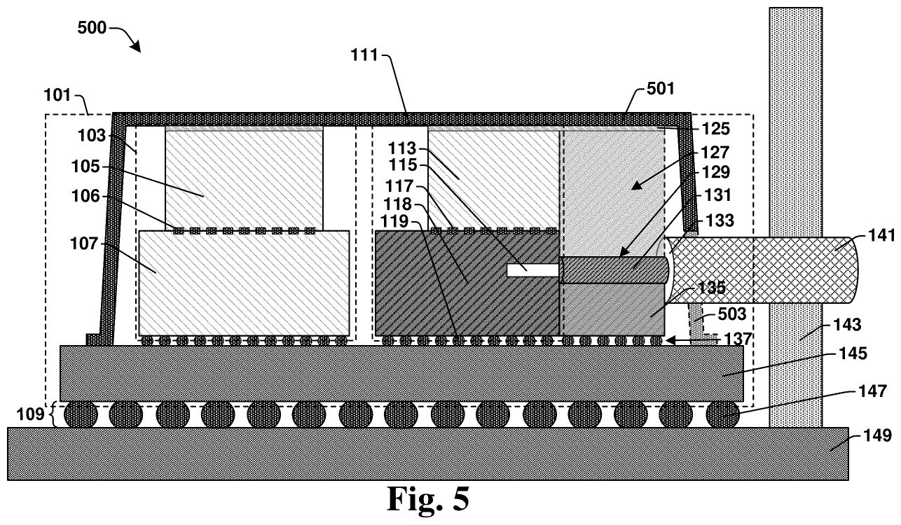

FIG. 5 illustrates a cross-sectional view of a system 500. The system 500 is like the system 100 of FIG. 1 except that the system 500 includes a lid 501 in place of the heat sink 121. The lid 501 is another type of heat spreader and may be or comprise a metal. The lid 501 may rest on the package substrate 145. The lid 501 may have a slot 503 so that the lid 501 fits over the optical fiber 141. Optionally, the heat sink 121 of FIG. 1 or the cold plate 401 of FIG. 4 is placed over the lid 501.

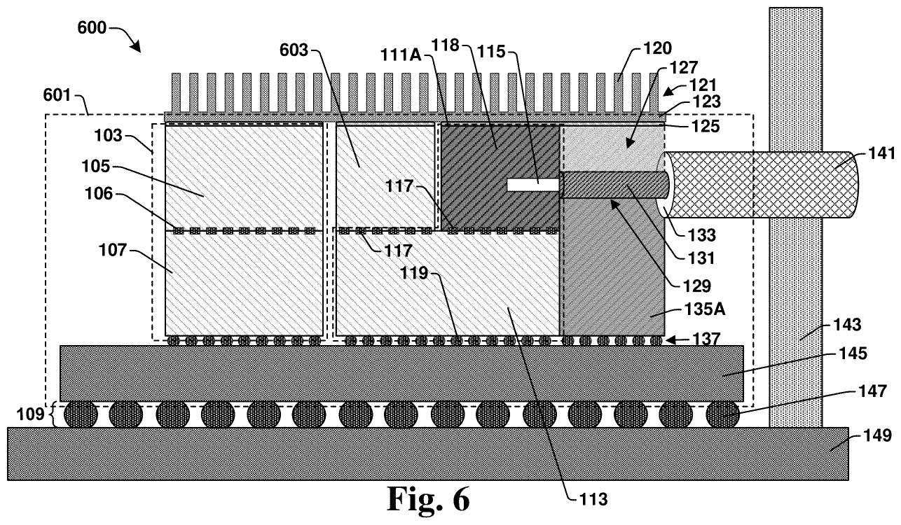

FIG. 6 illustrates a cross-sectional view of a system 600. The system 600 may be like the system 100 of FIG. 1 except that the system 600 has the chip package 601 in place of the chip package 101. The chip package 601 is like the chip package 101 but has the OE 111A in place of the OE 111 and the FMU 135A in place of the FMU 135. In the OE 111A, the OE PIC die 118 is vertically stacked over the OE EIC die 113. This configuration allows an additional EIC die 603 to be vertically stacked with the OE EIC die 113 where it is proximate the heat spreader 123. The additional EIC die 603 may implement any of the functions described as possibilities for the first EIC die 105 or the second EIC die 107. It is also possible to offload functions of the OE EIC die 113 to the additional EIC die 603, in which case the more heat intensive functions may be selected for offloading. The FMU 135A is like the FMU 135 of FIG. 1 except that the cavity 127 is shallower so as to align the optical fiber 141 with the edge coupler 115 in the OE PIC die 118 that is above the OE EIC die 113.

The additional EIC die 603 is coupled to the OE EIC die 113 through contact pads 117, solder micro bumps, or another type of high density connection, such as hybrid-bond. Vertical stacking with this type of connectivity may enable higher speed or lower loss communications between the additional EIC die 603 and the OE EIC die 113 than would be possible if the connection were routed through a package substrate.

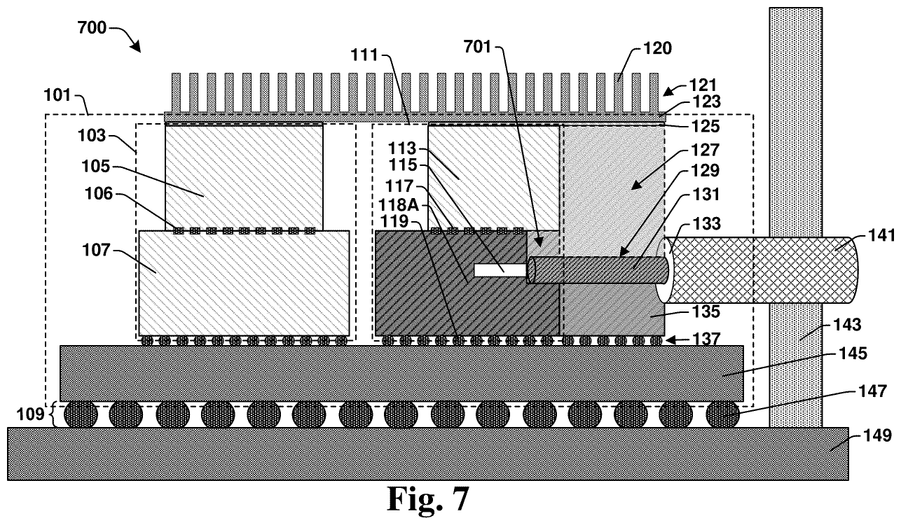

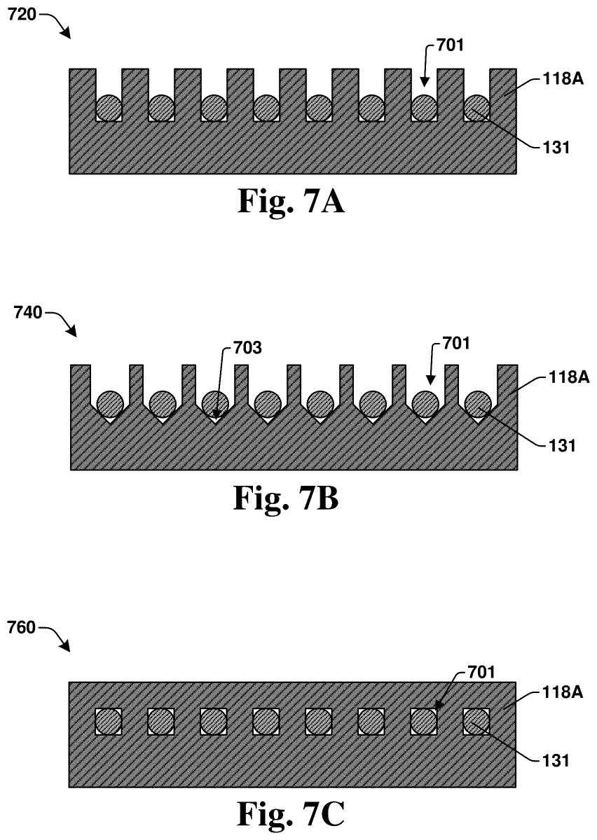

FIG. 7 illustrates a cross-sectional view of a system 700. The system 700 may be like the system 100 of FIG. 1 except that the system 700 uses the OE PIC die 118A in place of the OE PIC die 118. The OE PIC die 118A differs from the OE PIC die 118 of FIG. 1 in that the OE PIC die 118A has a cavity 701 for receiving the end portion 129 of the optical fiber 141. The cavity 701 may increase the accuracy with which the optical fiber 141 is positioned relative to the edge coupler 115 and may thereby improve the coupling efficiency.

FIG. 7A illustrates an end view 720 of the OE PIC die 118A in accordance with an embodiment in which the cavities 701 are rectangular trenches. Rectangular trenches may be formed, for example, by a dry etch process such as plasma etching or the like.

FIG. 7B illustrates an end view 740 of the OE PIC die 118A in accordance with an embodiment in which the cavities 701 are trenches having V-shaped grooves 703 at their bottoms. Trenches with V-shaped grooves 703 may be formed, for example, by a wet etch process or the like. The V-shaped grooves 703 may improve an alignment of the cores 131.

FIG. 7C illustrates an end view 760 of the OE PIC die 118A in accordance with an embodiment in which the cavities 701 are holes formed in the side of the OE PIC die 118A. Holes may be etched in the side of the OE PIC die 118A by a dry etch process or the like. Holes in the OE PIC die 118A may provide more precise alignment of the cores 131 than trenches.

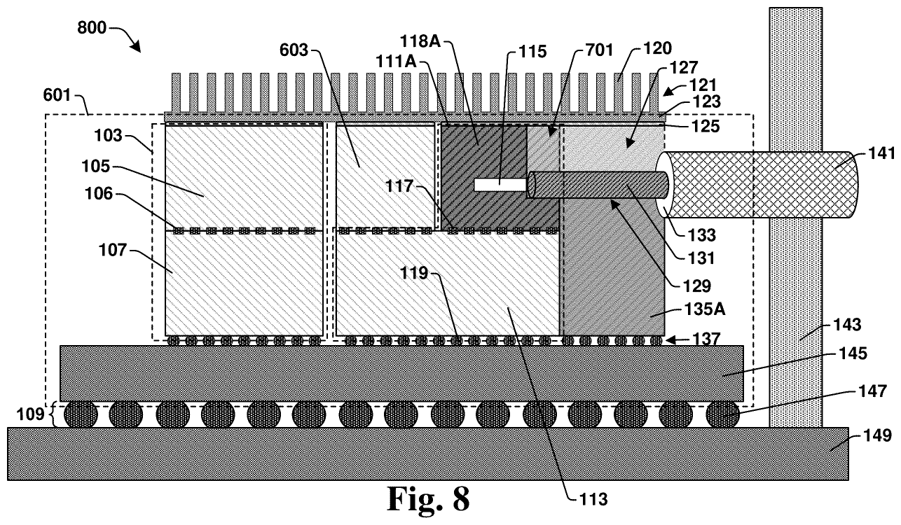

FIG. 8 illustrates a cross-sectional view of a system 800. The system 800 may be like the system 600 of FIG. 6 except that the system 600 uses the OE PIC die 118A in place of the OE PIC die 118. The system 800 combines advantages of the system 600 of FIG. 6 with advantages of the system 700 of FIG. 7.

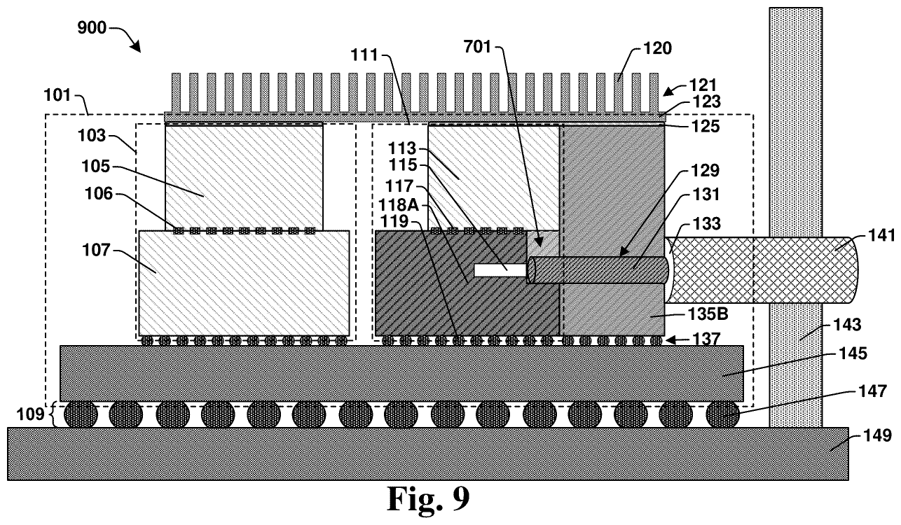

FIG. 9 illustrates a cross-sectional view of a system 900. The system 900 may be like the system 700 of FIG. 7 except that the system 900 uses the FMU 135B in place of the FMU 135. The FMU 135B differs from the FMU 135 in that the FMU 135B may lack the cavity 127 (see FIG. 7). In the FMU 135B, rather than resting in a cavity 127 the end portion 129 is embedded in the FMU 135B. Embedding may increase the security with which the end portion 129 is held and may make coupling between the optical fiber 141 and the edge coupler 115 more stable and efficient under exposure to vibrations or other such mechanical perturbations.

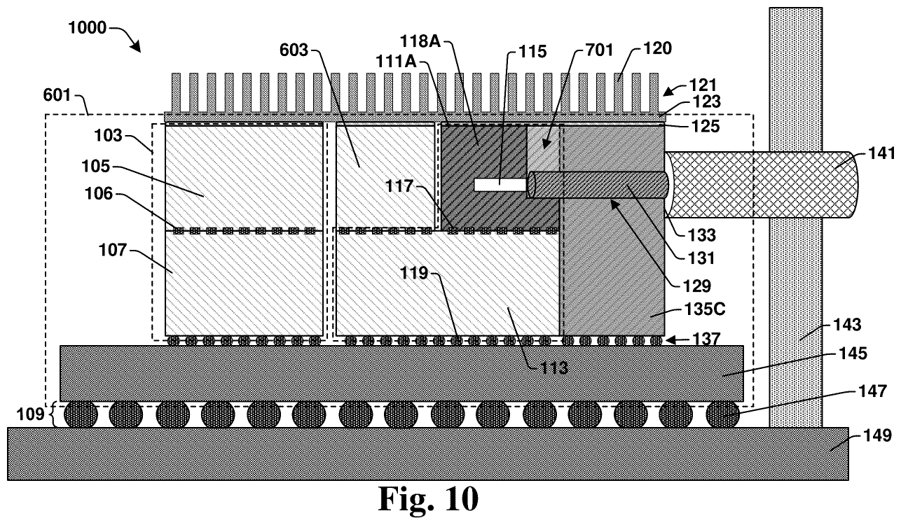

FIG. 10 illustrates a cross-sectional view of a system 1000. The system 1000 may be like the system 800 of FIG. 8 except that the system 1000 uses the FMU 135C in place of the FMU 135A. The system 1000 combines advantages of the system 800 of FIG. 8 with advantages of the system 900 of FIG. 9.

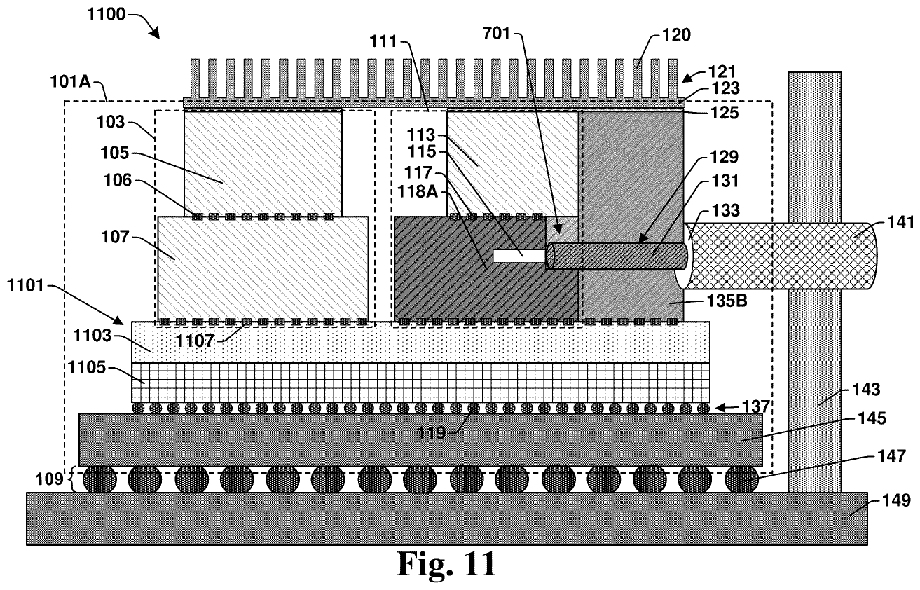

FIG. 11 illustrates a cross-sectional view of a system 1100. The system 1100 may be like the system 100 of FIG. 1 except that the system 1100 has the chip package 101A in place of the chip package 101. The chip package 101A may be like the chip package 101 (see FIG. 1) except that the chip package 101A uses the silicon interposer 1101. The silicon interposer 1101 may be used in addition to the package substrate 145, in which case the package substrate 145 may comprise a dielectric substrate. The silicon interposer 1101 includes a dielectric layer 1103 over a semiconductor substrate 1105. A metal interconnect structure (not shown) maybe formed in the dielectric layer 1103. The dielectric layer 1103 may include one or more layers of any suitable dielectrics. In some embodiment, the dielectric layer 1103 includes a low-K dielectric. In some embodiment, the dielectric layer 1103 includes an extremely low-K dielectric. Examples of low-K dielectric include organosilicate glasses (OSG) such as carbon-doped silicon dioxide, fluorinated silica glass (FSG), porous silicate glass, or the like. An extremely low-K dielectric may be a low-K dielectric with porosity that reduces the effective dielectric constant. The vertical stack 103 and the OE 111 may be coupled to the silicon interposer 1101 through contact pads 1107, solder micro bumps, or another type of high-density connection, such as hybrid-bond. The silicon interposer 1101 may increase data rates and lower loss for communications between the vertical stack 103 and the OE 111.

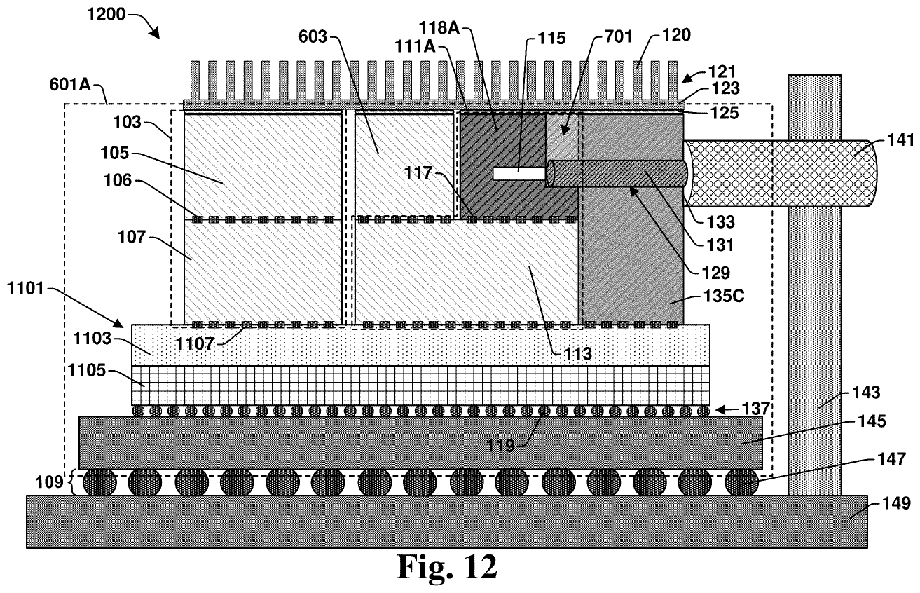

FIG. 12 illustrates a cross-sectional view of a system 1200. The system 1200 may be like the system 1000 of FIG. 10 except that the system 1200 has the chip package 601A in place of the chip package 601. The chip package 601A is like the chip package 601 (see FIG. 10) but uses the silicon interposer 1101. The system 1200 combines advantages of the system 1000 of FIG. 10 with advantages of the system 1100 of FIG. 11.

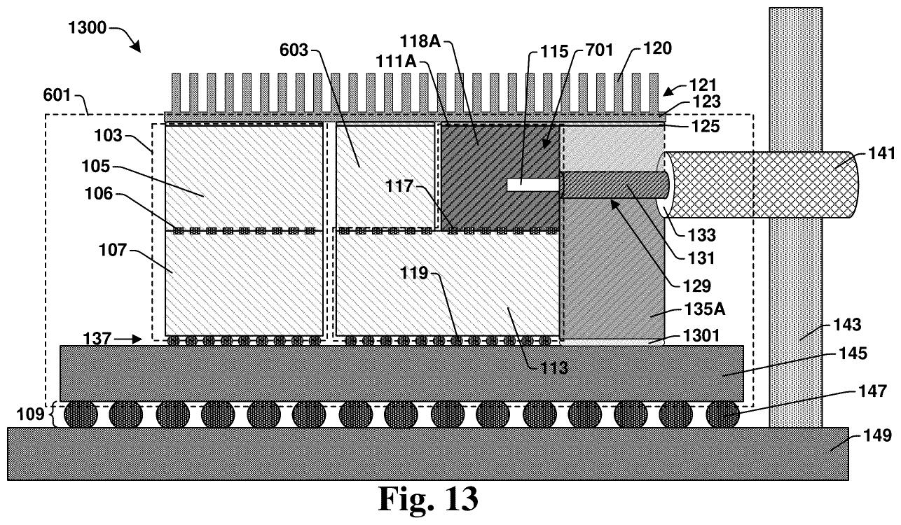

FIG. 13 illustrates a cross-sectional view of a system 1300. The system 1300 may be like the system 600 of FIG. 6 except that in the system 1300 the FMU 135A is glued to the package substrate 145 by glue 1301. The glue 1301 may be an epoxy, the like, or some other suitable type of glue. The glue 1301 may provide a more secure attachment of the FMU 135A than would the C4 connection structure 137.

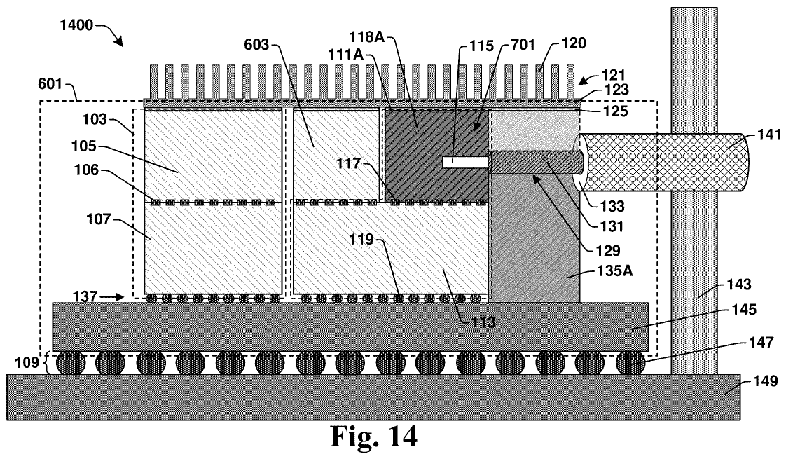

FIG. 14 illustrates a cross-sectional view of a system 1400. The system 1400 may be like the system 600 of FIG. 6 except that in the system 1400 the FMU 135A is bonded directly to the package substrate 145. In some embodiments, the bonding is covalent bonding. In some embodiments, the bonding is plasma-treated covalent bonding. Bonding may include dielectric-to-dielectric bonding, metal-to-metal bonding, or a combination of dielectric-to-dielectric bonding and metal-to-metal bonding. Contact pads may be inlaid within the FMU 135A to allow metal-to-metal bonding. A coating may be applied to a bottom surface of the FMU 135A and or to an upper surface of the package substrate 145 to promote dielectric-to-dielectric bonding or plasma-treated covalent bonding. In some embodiments, the coating includes silicon carbonitride (SiCN), silicon oxynitride (SiON), a combination thereof, or the like. Direct bonding may promote precision control over an elevation at which the FMU 135A holds the optical fiber 141.

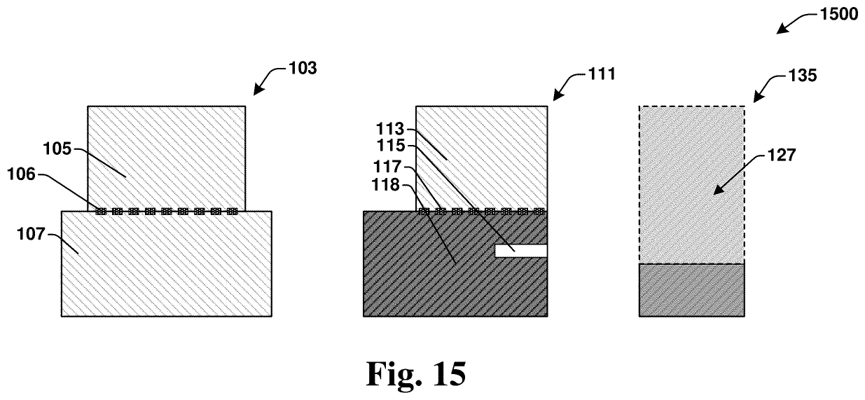

FIGS. 15-18 provide a series of cross-sectional views 1500-1800 that illustrate a system according to the present disclosure at various stages of manufacture according to a process of the present disclosure. Although FIGS. 15-18 are described in relation to a series of acts, it will be appreciated that the order of the acts may in some cases be altered and that this series of acts are applicable to structures other than the ones illustrated. In some embodiments, some of these acts may be omitted in whole or in part. Furthermore, FIGS. 15-18 are described in relation to a series of acts, it will be appreciated that the structures shown in FIGS. 15-18 are not limited to a method of manufacture but rather may stand alone as structures separate from the method.

As shown in FIG. 15, the method may begin with separate manufacturing of each of the vertical stack 103, the OE 111, and the FMU 135.

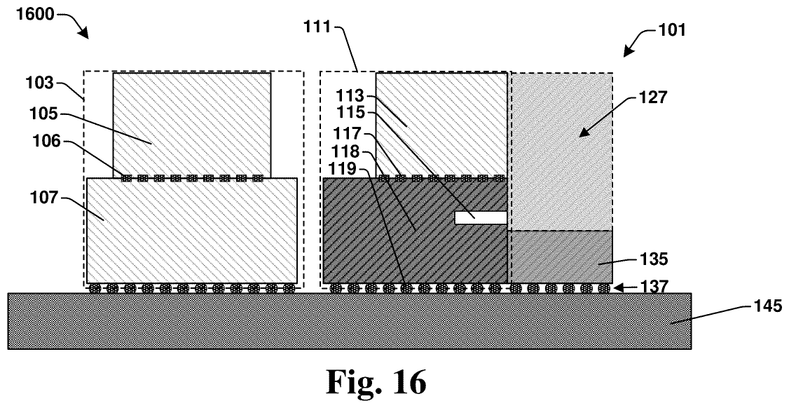

As shown in FIG. 16, the vertical stack 103, the OE 111, and the FMU 135 are each mounted on the package substrate 145 so as to form the chip package 101. In some embodiments, the OE 111 and the FMU 135 are made to abut. Optionally, alignment between the cavity 127 and the edge coupler 115 is fine-tuned during the bonding process. Index matching material (with refractive index close to ˜1.45, as for Si dioxide) may be applied to fill a gap between the OE111 and the FMU 135.

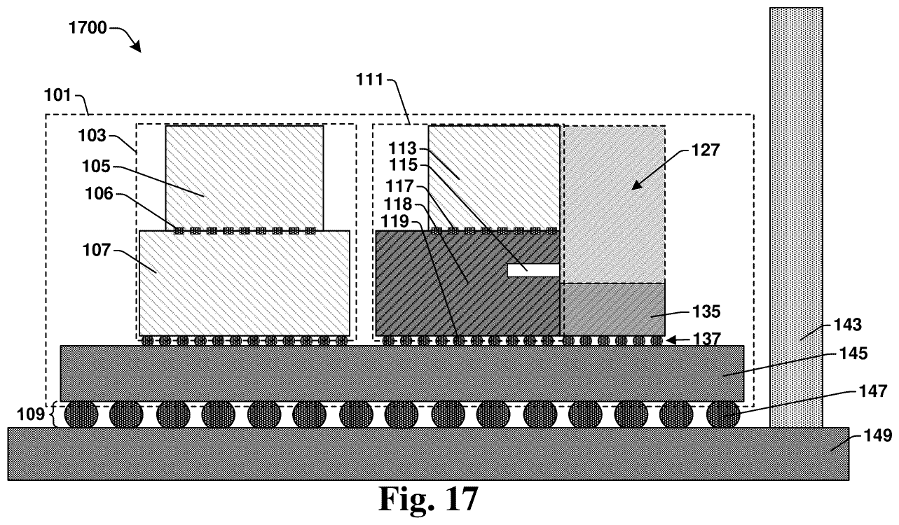

As shown in FIG. 17, the chip package 101 is mounted on a PCB 149. The PCB 149 generally includes a dielectric substrate and a metal interconnect structure. The chip package 101 may be mounted on the PCB 149 through the BGA 109. The BGA 109 may be attached to the chip package 101 before placement of the chip package 101 on the PCB 149. The fixture 143 may be attached to the PCB 149 before or after mounting the chip package 101.

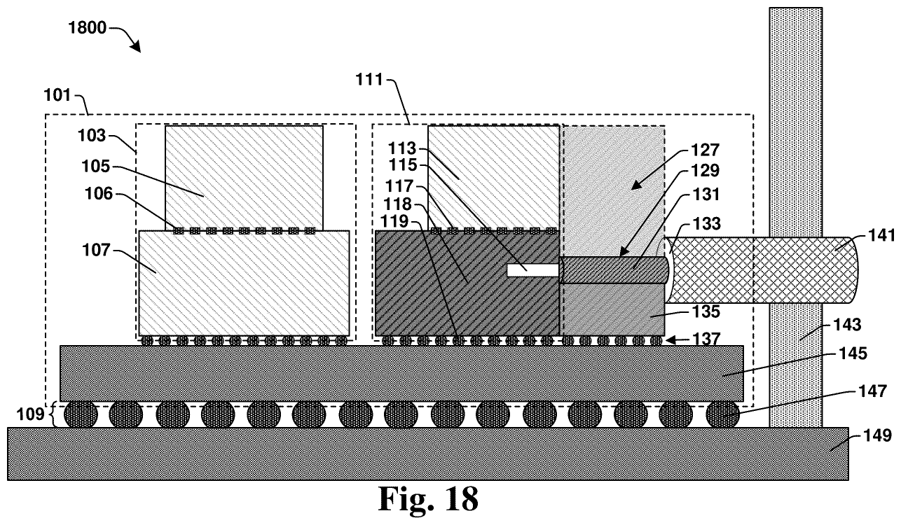

As shown in FIG. 18, the cladding 133 is stripped from the end portion 129 of the optical fiber 141 and the end portion 129 is placed in the cavity 127 so that the core 131 of the optical fiber 141 is aligned with the edge coupler 115 in the OE PIC die 118. The optical fiber 141 may then be secured to the fixture 143. In some embodiments, the fixture 143 surrounds the optical fiber 141. Optionally, the cavity 127 is filled in so that the end portion 129 is embedded within the FMU 135. The heat sink 121 may be placed over the chip package 101 to provide a structure such as the system 100 of FIG. 1.

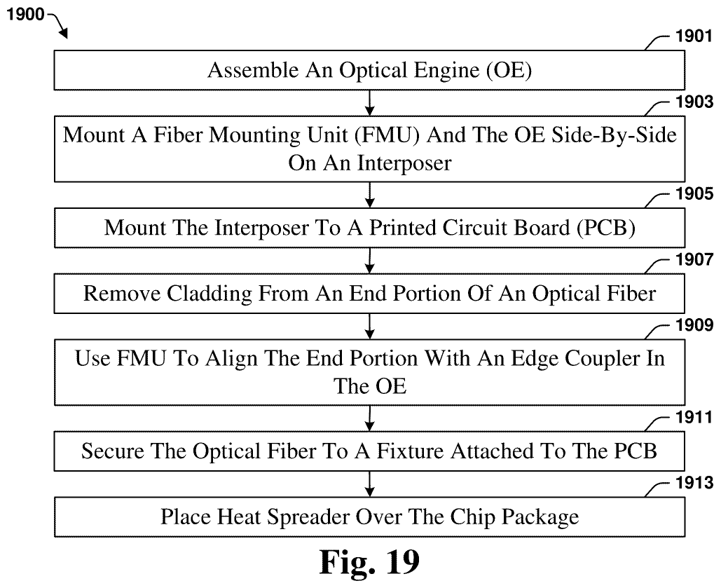

FIG. 19 provides a flow diagram for a method 1900 of forming a system according to some embodiments of the present disclosure. While the method 1900 is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

The method 1900 may begin with act 1901, assembling an OE comprising an OE PIC die and an OE EIC die in a vertical stack. In some embodiments, the OE EIC die is over the OE PIC die. The OE 111 in the system 100 of FIG. 1 provides an example. In some embodiments, the OE PIC die is over the OE EIC die. The OE 111A in the system 600 of FIG. 6 provides an example. In some embodiments, the vertical stack is formed during wafer level processing prior to dicing.

Act 1903 is mounting the OE and an FMU side-by-side on a package substrate. In some embodiments, the FMU abuts the OE. Optionally, other chips are mounted on the package substrate. The cross-sectional view 1600 of FIG. 16 provides an example.

Act 1905 is mounting the package substrate to a PCB. The package substrate may be connected to the PCB by a BGA, the like, or some other suitable structure. The cross-sectional view 1700 of FIG. 17 provides an example.

Act 1907 is removing the cladding from an end portion of an optical fiber. Act 1909 is using the FMU to align the end portion of the optical fiber with an edge coupler in the OE. Using the FMU to align the end portion may comprise placing the end portion in a cavity formed in the FMU. The cross-sectional view 1800 of FIG. 18 provides an example. In some embodiments, the end portions extend into cavities formed in the OE. The package substrate, the OE, the FMU together and optionally with additional chips and/or device layers form a chip package.

Act 1911 is securing the optical fiber to a fixture so that the optical fiber is supported independently from the FMU. The fixture may itself be attached to the PCB. The fixture may be any type of structure that provides physical support for the optical fiber or fiber array.

Act 1913 is placing a heat spreader over the chip package. Optionally, a thermal interface material is applied to the chip package and/or the heat spreader prior to placement on the chip package. The system 100 of FIG. 1, and the systems 400-1400 of FIGS. 4-14 are all examples of systems that may be made by this process.

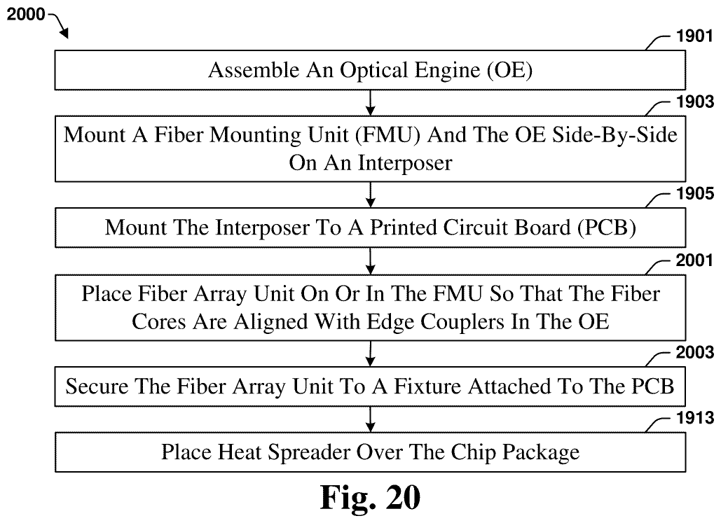

FIG. 20 provides a flow diagram for a method 2000, which is a variation of the method 1900 of FIG. 19. The method 2000 includes act 2001, placing a fiber array unit on or in the FMU, and act 2003, securing the fiber array unit to the fixture. The method 2000 is for use with fiber array units and FMUs of the type illustrated in FIGS. 3A-3C.

Some aspects of the present disclosure relate to a chip package that includes a package substrate having a first side and a second side. An optical engine is bonded to the first side. The optical engine comprises an electrical integrated circuit die and a photonic integrated circuit die in a vertical stack. The photonic integrated circuit die includes an edge coupler. A fiber mounting unit is bonded to the first side adjacent the optical engine. The fiber mounting unit holds an optical fiber in alignment with the edge coupler.

Some aspects of the present disclosure relate to a chip package that includes a package substrate, an optical engine, and a fiber mounting unit. The optical engine includes a photonic integrated circuit die and an electrical integrated circuit die mounted to and electrically coupled with the package substrate. The photonic integrated circuit die includes an edge coupler. The fiber mounting unit is a structure that is mounted to the package substrate side-by-side with the optical engine and has a first cavity positioned to hold an optical fiber in alignment with the edge coupler.

Some aspects of the present disclosure relate to a method of assembling a chip package. The method includes forming an optical engine that includes an electrical integrated circuit die bonded to a photonic integrated circuit die in a vertical stack, mounting the optical engine on a package substrate, mounting a fiber mounting unit on the package substrate, stripping cladding from an end portion of an optical fiber to provide an exposed core, and mounting the end portion in alignment with an edge coupler of the photonic integrated circuit die. The fiber mounting unit holds the end portion.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A chip package, comprising:
a package substrate having a first side and a second side, wherein the package substrate comprises a dielectric substrate or a silicon interposer;
an optical engine bonded to the first side, wherein the optical engine comprises an electrical integrated circuit die and a photonic integrated circuit die in a vertical stack, and the photonic integrated circuit die comprises an edge coupler; and
a fiber mounting unit bonded to the first side adjacent the optical engine, wherein the fiber mounting unit holds an optical fiber in alignment with the edge coupler.

2. The chip package of claim 1, further comprising a heat spreader, wherein the heat spreader is over the optical engine.

3. The chip package of claim 1, wherein the electrical integrated circuit die is over the photonic integrated circuit die.

4. The chip package of claim 1, further comprising a second electrical integrated circuit die bonded to and over the electrical integrated circuit die, wherein the photonic integrated circuit die is over the electrical integrated circuit die.

5. The chip package of claim 1, wherein the photonic integrated circuit die defines a cavity, and a core of the optical fiber extends from the fiber mounting unit into the cavity.

6. The chip package of claim 1, wherein the optical fiber comprises a core and cladding around the core, and the cladding is stripped from the core at an end of the optical fiber that is within the fiber mounting unit.

7. The chip package of claim 1, wherein the optical fiber is embedded in the fiber mounting unit.

8. The chip package of claim 1, wherein the optical fiber is within a fiber array unit held by the fiber mounting unit.

9. The chip package of claim 1, wherein the fiber mounting unit is soldered to the first side.

10. The chip package of claim 1, wherein the fiber mounting unit is glued to the first side.

11. The chip package of claim 1, wherein the fiber mounting unit is bonded to the first side by dielectric-to-dielectric bonding.

12. The chip package of claim 1, wherein the fiber mounting unit has a same height as the optical engine.

13. The chip package of claim 1, further comprising a chip stack bonded to the first side, wherein the chip stack and the optical engine are coextensive in height.

14. The chip package of claim 1, wherein the package substrate is a silicon interposer.

15. A system, comprising;
a printed circuit board, wherein the chip package of claim 1 is mounted on the printed circuit board; and
a fixture, wherein the fixture supports the optical fiber and is attached to the printed circuit board.

16. A chip package, comprising:
a package substrate, wherein the package substrate comprises a dielectric substrate or a silicon interposer;
an optical engine comprising a photonic integrated circuit die and an electrical integrated circuit die mounted to and electrically coupled with the package substrate, wherein the photonic integrated circuit die comprises an edge coupler; and
a fiber mounting unit, wherein the fiber mounting unit is mounted to the package substrate side-by-side with the optical engine and has a first cavity positioned to hold an optical fiber in alignment with the edge coupler.

17. The chip package of claim 16, wherein the photonic integrated circuit die comprises a second cavity positioned to hold an optical fiber in alignment with the edge coupler.

18. A method of assembling a chip package, the method comprising:
forming an optical engine that comprises an electrical integrated circuit die bonded to a photonic integrated circuit die in a vertical stack;
mounting the optical engine on a package substrate, wherein the package substrate comprises a dielectric substrate or a silicon interposer;
mounting a fiber mounting unit on the package substrate;
stripping cladding from an end portion of an optical fiber to provide an exposed core; and
mounting the end portion in alignment with an edge coupler of the photonic integrated circuit die, wherein the fiber mounting unit holds the end portion.

19. The method of claim 18, wherein mounting the end portion in alignment with the edge coupler further comprises inserting the end portion into a cavity formed in the photonic integrated circuit die.

20. The method of claim 18, further comprising:
mounting the package substrate to a printed circuit board;
attaching a fixture to the printed circuit board; and
using the fixture to support the optical fiber.
